(19) United States
(12) Patent Application Publication
(10) Pub. No.: US 2008/0006434 A1
(43) Pub. Date: Jan. 10, 2008

(54) Low Thermal Conductivity Reusable Insulation Jacket for Pipe, Tubing, Valves, and Fittings

(76) Inventors: Jacob G. Nygaard, Everett, WA (US); Noble Nygaard, Roberts, WI (US); Susan Nygaard, Roberts, WI (US); Nathan Nygaard, River Falls, WI (US)

Correspondence Address: JACOB NYGAARD, 1004 KIRKLAND AVE., # 4, KIRKLAND, WA, 98033, US

(21) Appl. No.: 11/774,669

(22) Filed: Jul. 9, 2007

Related U.S. Application Data
(60) Provisional application No. 60/853,325, filed on Jul. 7, 2006.

(51) Int. Cl. H02G 15/08

(52) U.S. Cl. 174/93

(57) ABSTRACT

A reusable insulation jacket for straight industrial tubing, as well as elbow, union, coupling, tee, valve, and other connectors carrying extreme hot and cold materials comprises a thin insulating mat. For straight tubing, the jacket is of a width as to completely wrap the tubing and overlap itself. For tubing connectors, the jacket is stitched and stuffed (manufactured) to form a cavity as to completely receive the tubing connector. In all forms, the jacket will overlap itself whereat complimentary releasable fastening hook and loop material securely hold the jacket in place to insulate the tubing or tubing connector and to prevent an individual from otherwise being burned from contacting the tubing or tubing connector. Additionally, the jacket has properties as to insulate much more efficiently then fiberglass insulation, allowing a much lower profile to accomplish equal insulation characteristics which allows more insulated tubing in a smaller area.

### CROSS-REFERENCE TO RELATED APPLICATIONS

This application claims priority of provisional application 60/853,325 which was filed Jul. 7, 2006.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to an insulation jacket for tubing, and more particularly, to a reusable insulation jacket for tubing and tubing fittings which convey steam, hot materials, condensate, lubricants, cryogenic fluids and cold materials typically used in heating and air conditioning, power facilities, food processing facilities and petrochemical facilities.

While cryogenic fluids approach absolute zero, steam for use in power may typically range between 270° F. and 300° F., and can be much hotter. These temperatures will easily burn an individual should they come in contact with either of these materials or the tubing, piping or conduiting transporting such materials or steam.

Such extreme temperature steam and cold materials conveyed in tubing are common in industrial applications, such as boilers and petrochemical plants, and typically requiring insulation about the tubing. Asbestos is no longer used. While fiberglass insulation materials are commonly used, known applications are generally not very sophisticated and require substantial installation time and further treatment for preservation of the insulation against weather, moisture and other harsh chemicals. Fiberglass insulation applications typically require thick sections to achieve desired insulation characteristics.

Conventional insulation methods permanently insulate valves and fittings. It is common in many applications for valves and fittings to require maintenance in the form of inspection and replacement. In these applications, increased down time and cost is incurred due to the necessity to remove the permanent insulation and to reinsulate with the same inefficient permanent insulation method. It is also of note that the increased time and cost presents the risk of not reinsulating.

New construction requires consideration given to spacing between pipes. Traditional fiberglass insulation methods require significant spacing depending on desired insulating characteristics.

Traditional fiberglass pipe insulation packaging consumes significant space in regards to shipping and handling. Additional time is consumed handling the bulky packaging. Also, significant storage considerations are required depending on job size.

There is a significant need for a reusable, easy-to-use, low profile insulation jacket that insulates substantially better than fiberglass which will readily cover tubing in an easy fashion in application and removal.

### BRIEF SUMMARY OF THE INVENTION

A reusable insulation jacket for tubing carrying extreme hot and cold materials comprises a polygonal insulating jacket. The jacket is of a width as to completely wrap the tubing and overlap itself whereat complimentary releasable fastening means securely hold the jacket in place to insulate the tubing and to prevent an individual from otherwise being burned from contacting the tubing.

A principal object and advantage of the present invention is that the reusable insulation jacket is simple to apply, easy to remove and furthermore reusable.

Another object and advantage of the present invention is that it is relatively inexpensive to manufacture and saves a significant amount of man hours in both application and reusable removal.

Another object and advantage of the present invention is that it has properties such that it insulates significantly better than traditional fiberglass insulation, allowing substantially less thickness to accomplish the same insulating qualities.

Another object and advantage of the present invention is that due to its lower (thinner) profile, the packaging, shipping, handling, and storage is vastly improved over traditional insulations (such as fiberglass) while providing equivalent insulating properties.

Another object and advantage of the present invention is that it may be used to protect bare tubing, tube splices, tube ends, fitting and valves.

Other objects and advantages will become obvious with the reading of the following specification and appended claims with a review of the Figures.

### BRIEF DESCRIPTION OF THE SEVERAL VIEWS OF THE DRAWINGS

FIG. 1 is a side view of the present invention;

FIG. 2 is a top view of the present invention;

FIG. 3 is a bottom view of the present invention;

FIG. 4 is the present invention partially installed to demonstrate installation;

FIG. 5 is the present invention installed on a pipe or tube;

FIG. 6 is a perspective view of an opened jacket around an elbow;

FIG. 7 is a front view of a partially assembled jacket on an elbow to demonstrate assembly;

FIG. 8 is a front view of an assembled jacket on an elbow;

FIG. 9 is a front view of an unassembled jacket prior to fastening to a tee fitting;

FIG. 10 is a front view of a partially assembled jacket on a tee to demonstrate assembly;

FIG. 11 is a front view of an assembled jacket on a tee;

FIG. 12 is a front view of a jacket for a union;

FIG. 13 is a perspective view of a partially assembled jacket on a union to demonstrate; assembly;

FIG. 14 is a front view of an assembled jacket on a union.

DETAILED DESCRIPTION OF THE INVENTION

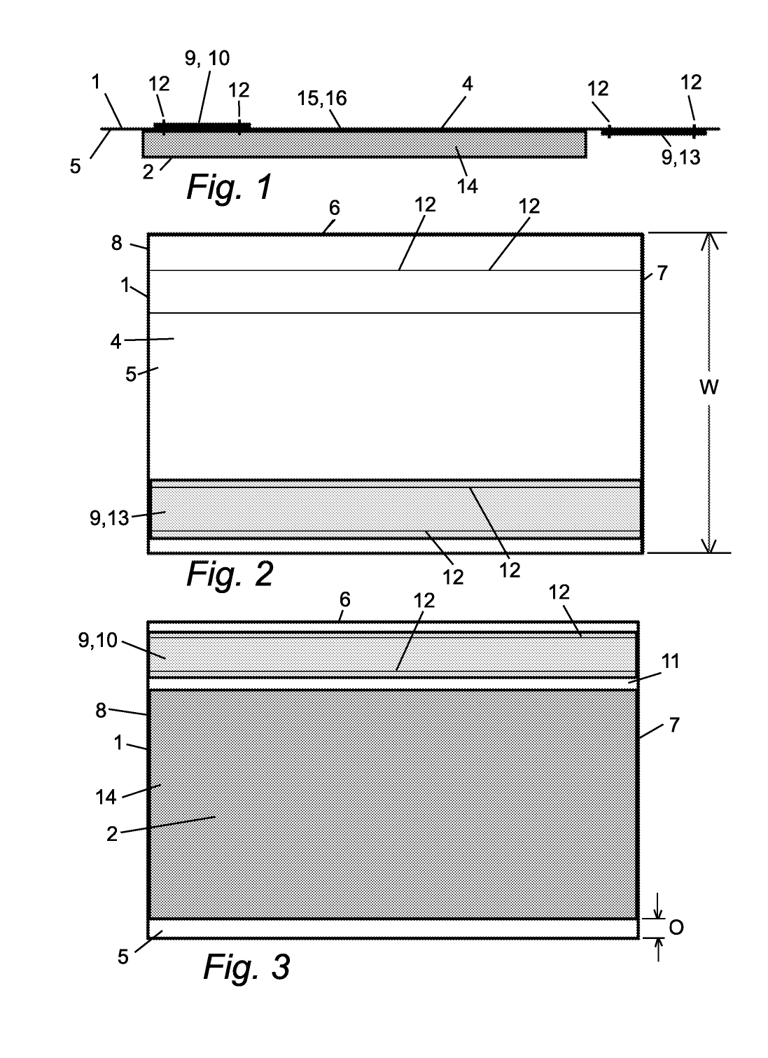

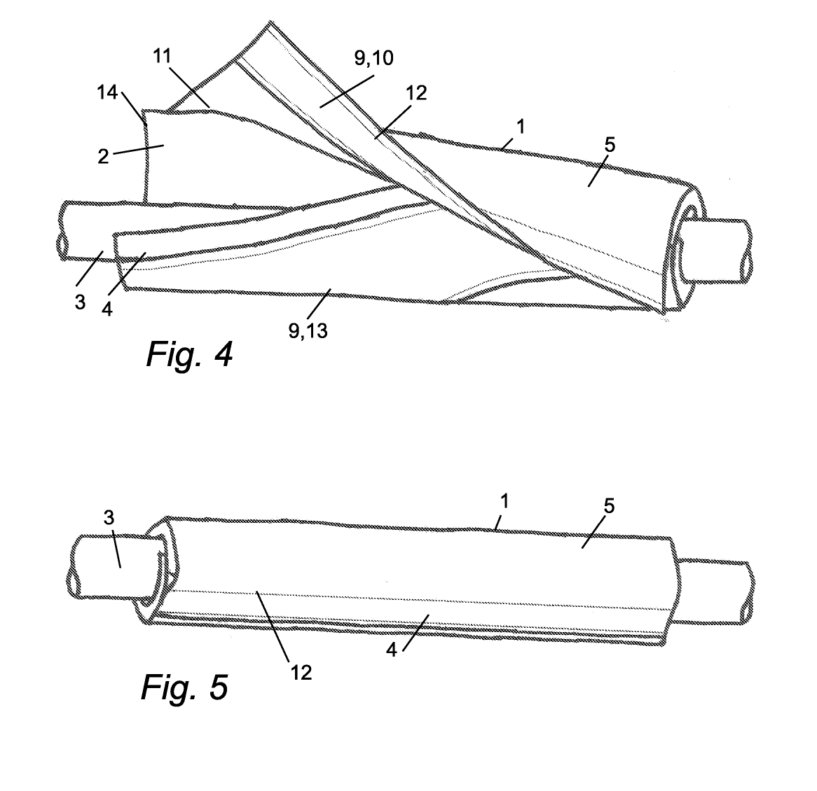

Referring to FIGS. 1 through 5, the jacket 1 may be seen and understood in construction and use.

More specifically, the jacket 1 illustratively may come in three (3) foot lengths approximating three and a half (3.5) inches wide and one quarter (¼) inch thick for one half (½) inch tubing 3. Please note that dimensions explained are for illustrative purposes only and are not to be deemed restrictive in interpretation. The jacket 1 has an inside face 2 which will confront tube 3 and an outside face 4. Suitably the outer layer 5 is used to seal the jacket 1 from moisture, water and harsh chemicals such as with a silicone impregnated fiberglass cloth 5. The jacket 1 has a first elongate side 6 and a second elongate side 7, and is suitably of a predetermined width as previously described. Upon severing the jacket 1 in manufactured lengths, it will then have a first short end 8 and an opposing second short end 7.

Fastening means 9 are suitably used with the invention. Applicant has found that hook and loop materials, such as Velcro, work well with this application. The hook material 10 is suitably affixed to the inside face 11 of the outer layer 5 appropriately along the first elongate side 6 and held thereat appropriately by stitching 12. A second complimentary loop material 13 is also on the outside face 4 and suitably adjacent or close to the second elongate side 7 and held thereat by stitching 12. Advantageously, the loop material 13 is spaced inward somewhat from the second elongate side 7 as to assure that the mat 14 will completely wrap around and overlap (Arrow O in FIG. 3) itself when insulating tubing 3.

The insulating material (mat) 14 is secured to the inner face 11 of the outer layer 5. This securement is achieved through silicone adhesive 15 or stitching 16 between the layers. Other fastening means may be used for the intent of attaching the insulating material 14 to the outer layer 5.

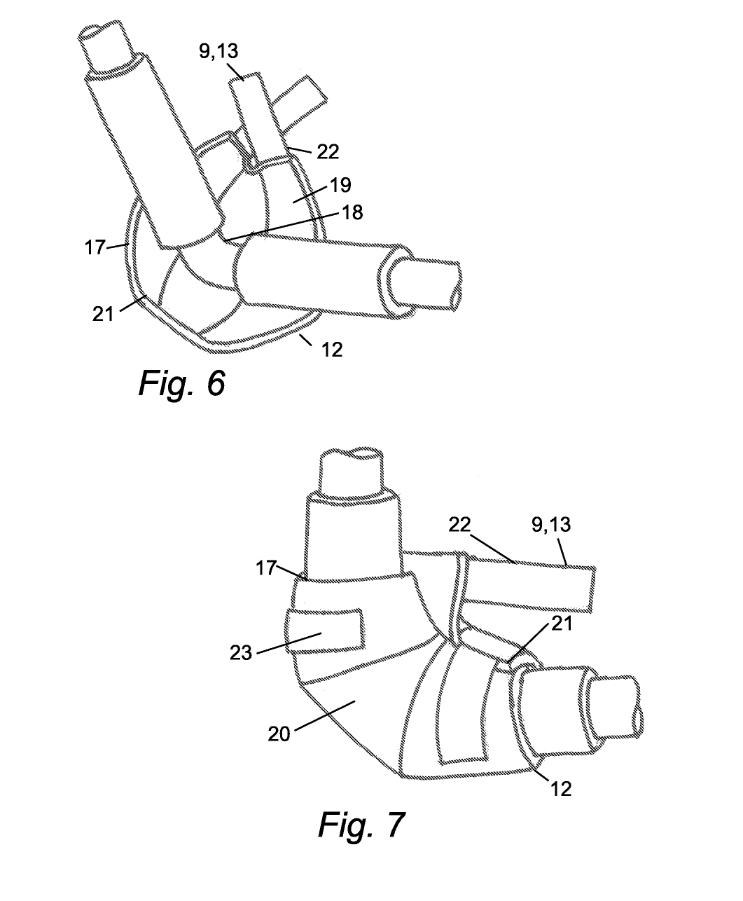

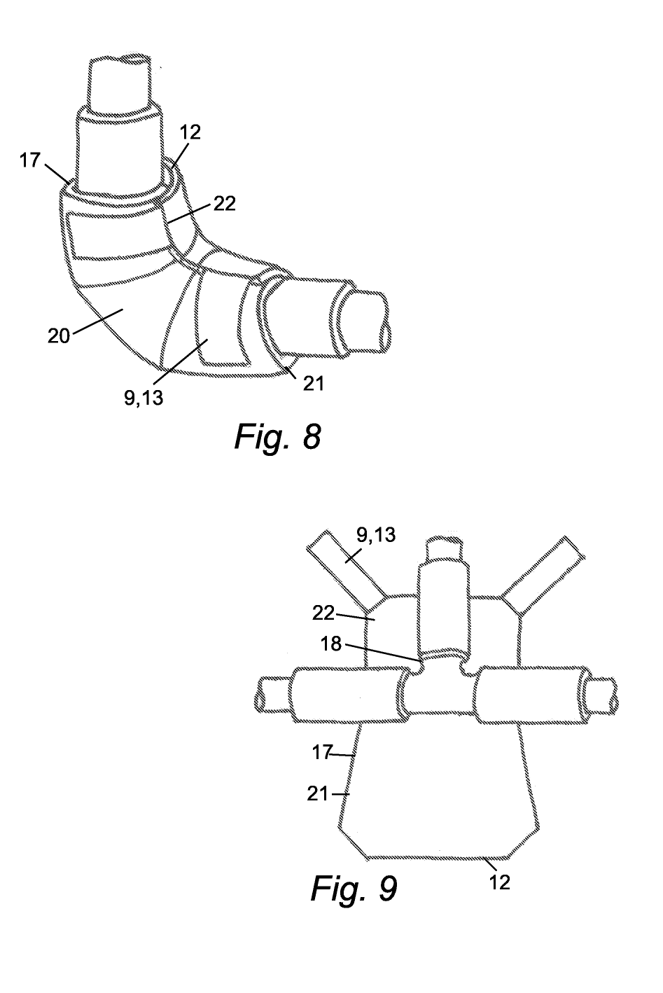

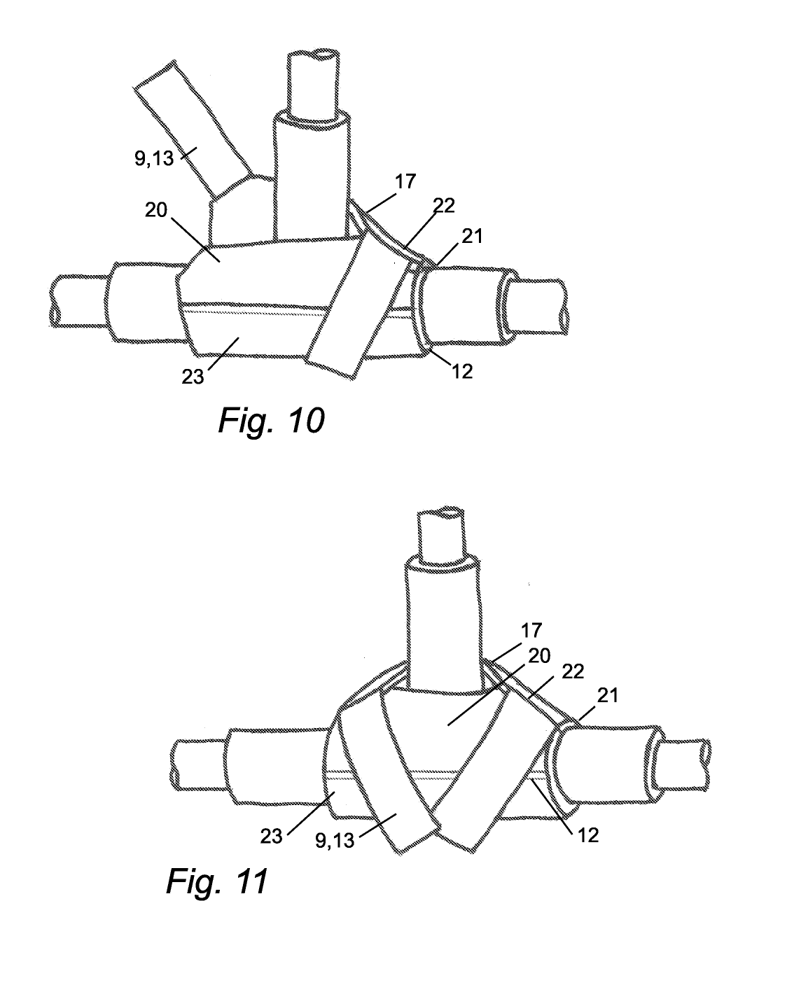

Referring to FIGS. 6 through 14, the jacket 1 may be seen to take another shape such as the jacket 17. The jacket 17 is generally shaped to receive the fitting 18 it is insulating.

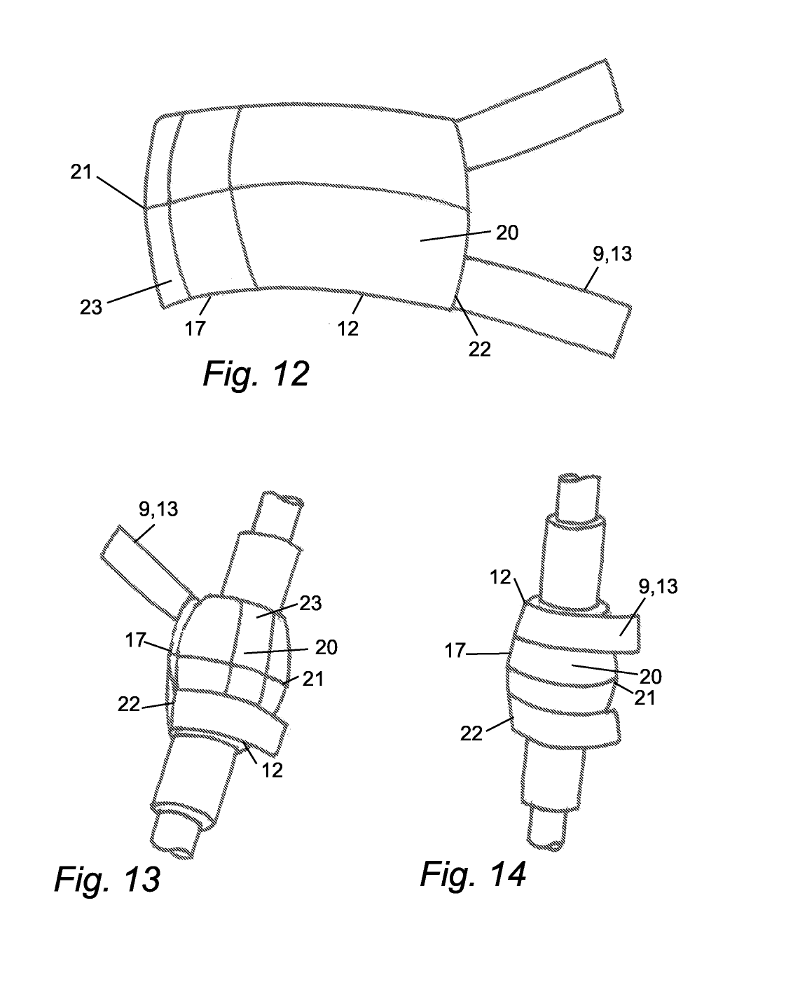

More specifically, the jacket 17 has an inside face 19 and an outside face 20 comprised of a protective, durable outer layer as previously discussed. FIG. 12 shows a jacket 17 in an unassembled condition where the jacket has not been assembled to a fitting. During construction, the outer layer is cut to shape. Stitching 21 is then made in the outer layer comprised of the inside face 19 and outside face 20. After the stitching 21 is completed, the outer layer is then inverted to its outside-out condition clearly shown in FIG. 12. Along the peripheral edge 22 of the jacket 17 are located fastening means 9 which suitably may be hook material 13 fastened thereat by stitching 12 and loop material 23 attached thereat appropriately by stitching 12.

The present invention may be embodied in other specific forms without departing from the spirit of essential attributes thereof; therefore, the illustrated embodiment should be considered in all respects as illustrative and not restrictive, reference being made to the appended claims rather than to the foregoing description to indicate the scope of the invention.

I claim:

1. A reusable insulation jacket assembly for tubing, elbow, valve, and other tubing connectors which commonly convey steam, hot materials, condensate, lubricants, cryogenic fluids and cold materials typically used in heating and air conditioning, power facilities, food processing and petrochemical facilities, the insulation jacket assembly improvement comprising:
(a) a reusable, flexible insulating jacket having an inside face, an outside face, first and second elongate sides, a width and relatively short first and second ends, forming a cavity in which to encapsulate the fitting it is designed to insulate.
(b) complementary releasable fastening means fastened on the outside face along the peripheral edges as to permit the inside face to confront and the cavity to wrap around, one of the connectors and as to permit the fastening means to releasably interlock for securely holding the jacket around the one connector so that the jacket insulates the one connector with the insulation and prevents an individual from being burned from contacting the otherwise exposed tubing.

2. The insulation jacket of claim 1, further comprising materials and construction in which the jacket resists moisture, water and harsh chemicals.

3. The insulation jacket of claim 1, wherein the insulation material properties are such that the k-value is less than 0.13 BTU-in/hr-ft²-° F.@75° F.

4. The insulation jacket of claim 1, wherein the fastening means comprises complementary hook and loop materials.

5. The insulation jacket of claim 1, wherein the size of the jacket is large enough to permit the jacket to overlap itself as to assure the fastening means does not contact the tubing.

6. The insulation jacket of claim 1, wherein the thin jacket insulates as well as substantially thicker insulations. Example: One quarter (¼) inch of invention thickness insulates as well as one (1) inch of fiberglass insulation.
